(19) United States
(12) Patent Application Publication
(10) Pub. No.: US 2026/0163028 A1
(43) Pub. Date: Jun. 11, 2026

(54) HUMIDIFIER

(71) Applicant: MAHLE International GmbH, Stuttgart (DE)

(72) Inventor: Samuel Kohler, Weil im Schoenbuch (DE)

(21) Appl. No.: 19/411,170

(22) Filed: Dec. 5, 2025

(30) Foreign Application Priority Data
Dec. 6, 2024 (DE) 102024136588.9

(51) Int. Cl. H01M 8/04119

(52) U.S. Cl. CPC H01M 8/04141; H01M 2250/20

(57) ABSTRACT

A humidifier for transferring humidity from an exhaust air flow to a supply air flow for a fuel cell system may include a humidifier block, a homogenizer configured to homogenize the exhaust air flow, and a housing in which the humidifier block and the homogenizer are arranged. The exhaust air flow and the supply air flow may be flowable through the humidifier block in a media-separated manner such that humidity from the exhaust air flow is transferrable to the supply air flow. The exhaust air flow may be flowable through the homogenizer. The housing may include an exhaust air inlet and an exhaust air outlet via which the exhaust air flow is suppliable to and dischargeable from the humidifier block. The housing may also include a supply air inlet and a supply air outlet via which the supply air flow is suppliable to and dischargeable from the humidifier block.

### CROSS-REFERENCE TO RELATED APPLICATIONS

This application claims priority to German Patent Application No. DE102024136588.9 filed on Dec. 6, 2024, the contents of which is hereby incorporated by reference in its entirety.

### TECHNICAL FIELD

The present invention relates to a humidifier for transferring humidity from a humid exhaust air flow to a dry supply air flow for a fuel cell system, in particular of a motor vehicle,

### BACKGROUND

For an optimized fuel cell process, it is beneficial to humidify a supply air flow fed to the respective fuel cell on the cathode side, i.e. to increase the proportion of vaporous water. Since the fuel cell process produces water on the cathode side anyway, a cathode-side exhaust air flow from the respective fuel cell contains a comparatively large amount of humidity in the form of vapor and liquid droplets. The humidity of the exhaust air flow can be used expediently for humidifying the supply air flow. A humidifier of the type mentioned above is used for this purpose. Depending on the operating status of the fuel cell system, the humid exhaust air flow may even contain liquid water, which can be detrimental to the humidifier. In addition, the dehumidified exhaust air flow may still contain liquid water, which can also be disadvantageous.

### SUMMARY

The present invention deals with the problem of providing an improved or at least another embodiment for a humidifier of the type described above, which is characterized in particular by an improved separation of liquid water from the exhaust air flow. At the same time, the aim is to achieve an embodiment that is associated with a low pressure loss when the air flows through the humidifier.

The invention solves this problem by the subject matter of the independent claim(s). Advantageous embodiments are the subject-matter of the dependent claim(s).

The invention is based on the general idea of providing in a housing of the humidifier an equalizing device for homogenizing the exhaust air flow, through which the exhaust air flow can flow and which is adapted such that, when it flows through, it homogenizes the exhaust air flow with respect to the cross-section through which the exhaust air flow passes, in particular with respect to the flow direction and/or with respect to the flow velocity. In other words, the exhaust air flow is homogenized such that the flow direction and/or flow velocity of the exhaust air flow is homogenized across the traversable cross-section. This means that the flow velocity and/or flow direction downstream of the homogenizer is largely the same over the cross-section through which the flow passes, whereas it can vary greatly upstream of the homogenizer over the cross-section through which the flow passes. The homogenization of the exhaust air flow reduces the pressure drop in the exhaust air flow and thus improves the low-resistance flow through the humidifier. At the same time, this simplifies the water separation from the exhaust air flow. In particular, homogenization can reduce the average flow velocity of the exhaust air flow, which favors water separation.

Specifically, the invention proposes equipping the humidifier with a humidifier block through which the exhaust air flow and the supply air flow can pass in a media-separated manner, thereby transferring humidity from the exhaust air flow to the supply air flow. Furthermore, the humidifier has a housing in which the humidifier block is arranged and which has a longitudinal direction of the housing, a transverse direction of the housing, and a vertical direction of the housing that run perpendicular to each other. The housing also has an exhaust air inlet for supplying the humid exhaust air flow to the humidifier block, an exhaust air outlet for discharging the dehumidified exhaust air flow from the humidifier block, has an supply air inlet for supplying the dry supply air flow to the humidifier block, and an supply air outlet for discharging the humidified supply air flow from the humidifier block. According to the invention, a homogenizer through which the exhaust air flow can flow is arranged in the housing for homogenizing the exhaust air flow. This homogenizer is arranged in the housing such that the exhaust air flow passes through it during operation of the humidifier.

Such a humidifier block can be formed, for example, using membranes that are permeable to humidity or water and substantially impermeable to air. In the present context, the terms “humid,” “dry,” “dehumidified,” and “humidified” are to be understood relatively, such that the dehumidified exhaust air contains less humidity than the humid exhaust air and the humidified supply air contains more humidity than the dry supply air.

According to an advantageous embodiment, the homogenizer may be positioned in a chamber through which the exhaust air flow can pass and adapted to direct liquid water present by the homogenizer to a wall opening connecting the chamber to a water collection chamber. The homogenizer thus acts as a water drain and improves water separation. Furthermore, a partition wall may be arranged in the housing of the humidifier, separating the water collection chamber, which may have a water drainage opening for discharging separated water, from the chamber. The chamber can be fluidically connected to the water collection chamber via the wall opening. Preferably, the wall opening extends from a side wall in the housing to the partition wall, preferably to a section of the partition wall adjacent to the wall opening.

Preferably, the chamber can be an exhaust air discharge chamber that discharges the exhaust air flow from the humidifier block and feeds it to the exhaust air outlet. In this case, the liquid water in the humidifier block can be used to transfer humidity to the supply air flow, as it is only separated downstream of the humidifier block.

In an alternative embodiment, however, the chamber may be designed as an exhaust air supply chamber that removes the exhaust air flow from the exhaust air inlet and feeds it to the humidifier block. At this point, a particularly large amount of liquid water can be separated from the exhaust air flow.

Since the homogenizer can be flowed through by the exhaust air flow, it has an upstream side and a downstream side. The homogenizer can now be conveniently arranged in the chamber so that the downstream side directs liquid water present by the downstream side toward the wall opening. Liquid water carried along in the exhaust air flow comes into contact with the homogenizer and can collect there. The exhaust air flow carries the water to the downstream side of the homogenizer. The homogenizer is adapted and arranged such that it directs the water to the wall opening. This ensures efficient water separation. On the one hand, the homogenizer forms a flow obstacle on which entrained water can settle. At the same time, every flow obstacle is accompanied by flow resistance and, as a result, a pressure loss. However, the homogenizing effect of the homogenizer more or less compensates for this pressure loss and can even overcompensate for it. This is because the flow cross-section downstream of the homogenizer is larger, reducing flow velocities and friction losses. As a result, the exhaust air flow downstream of the homogenizer has a higher overall pressure level than upstream of the homogenizer, so that the pressure loss caused by the homogenizer itself is compensated or even overcompensated.

In this context, “adaptation” corresponds to “embodiment” and/or “device,” so that the phrase “adapted so that” is synonymous with the phrase “designed so that” and/or “set up so that”.

In the case of advantageous further development, the downstream side can be located above the wall opening in relation to the vertical direction of the housing or flush with the wall opening. This ensures that water on the downstream side can be fed into the wall opening particularly easily and safely.

In another embodiment, the downstream side may extend transversely to the vertical direction of the housing and slope toward the wall opening. This allows the effect of gravity to be used to drain the water from the downstream side toward the wall opening. The homogenizer may be adapted to be flat on its downstream side.

A further embodiment proposes that the homogenizer fills the flowable cross-section of the chamber upstream of the wall opening, preferably completely. This prevents flow around the homogenizer, so that the entire exhaust air flow must flow through the homogenizer. This increases the efficiency of the separation effect and the homogenization effect of the homogenizer.

In a preferred embodiment, a deflection region can be formed in the chamber, which forms a flow curve and deflects the exhaust air flow. In particular, the deflection region can deflect the exhaust air flow relative to a deflection axis, which can extend parallel to the longitudinal direction of the housing, for example. Such a flow deflection generates inertial forces which cause the entrained water to be unable to follow the deflection as well as the exhaust air flow. The water can therefore settle in the deflection region on the wall which bounds the deflection region on the outside of the curve. Investigations by the applicant have shown that, due to the inertial effect, an inhomogeneous flow can form, particularly in a deflection region. In a region that is relatively close to a deflection axis around which the exhaust air flow is deflected in the deflection region, a comparatively low volume flow or a comparatively low flow velocity prevails. In contrast, a significantly higher volume flow or a significantly higher flow velocity occurs in a region remote from the deflection axis. This means that the exhaust air flow within the deflection region is inhomogeneous with respect to the flow velocity or the volume flow per cross-sectional unit transverse to its flow direction. The homogenizer can now be arranged in the deflection region and, in particular, adapted to homogenize the exhaust air flow with regard to the flow velocity. This causes the homogenizer to slow down the exhaust air flow in the region of higher flow velocities due to greater flow resistance, which leads to a pressure increase on the upstream side of the homogenizer. This pressure increase on the upstream side in turn leads to an acceleration of the exhaust air flow in the region of lower flow velocities. Since there is also less flow resistance there as a result of the homogenizer, the exhaust air flow is homogenized in terms of flow velocity across the flowable cross-section of the deflection region downstream of the homogenizer as it flows through the homogenizer. In other words, regions that were previously characterized by lower flow velocities upstream of the homogenizer have higher flow velocities downstream of the homogenizer, and regions that were previously characterized by higher flow velocities upstream of the homogenizer exhibit lower flow velocities downstream of the homogenizer, so that the flow across the flowable cross-section of the deflection region downstream of the homogenizer has been slowed down overall and has a more uniform velocity profile. Homogenization of the exhaust air flow allows better utilization of the available flowable cross-section. Since the velocities and friction losses are also reduced, the pressure loss caused by the homogenizer itself is compensated. It is also advantageous to position the wall opening in the deflection region so that it is located in the region where water is preferentially separated.

According to an advantageous embodiment, the deflection region may be adapted to deflect the exhaust air flow with respect to a deflection axis running parallel to the longitudinal direction of the housing, wherein the wall opening is adjacent to the homogenizer on a side facing away from the deflection axis. In addition or alternatively, the homogenizer may be arranged in the housing between the deflection axis and the wall opening. These measures promote water separation and homogenization.

In addition or as an alternative, it may also be provided that the flow resistance of the homogenizer increases with increasing distance from the deflection axis. The homogenizer has a flow resistance for the exhaust air flow. The exhaust air flow has an inhomogeneous distribution of flow velocity in the deflection region, such that the flow velocity of the exhaust air flow increases with increasing distance from the deflection axis. Due to the increase in flow resistance with increasing distance from the deflection axis, the exhaust air flow in regions with higher flow velocities encounters greater flow resistance, which supports the homogenization of the exhaust air flow.

The flow resistance correlates, among other things, with the thickness of the homogenizer measured in the flow direction, so that it may be provided, in particular, that the thickness of the homogenizer increases in the vertical direction of the housing as the distance from the deflection axis increases.

According to another embodiment, the homogenizer may have several homogenizing channels through which the exhaust air can flow in parallel and which are aligned parallel to each other, each of which has a flow resistance, each of which has a channel length measured in the flow direction of the exhaust air, and each of which has a channel cross-section through which the exhaust air can flow. The channel length corresponds in particular to the distance between the upstream side and the downstream side of the homogenizer at the respective homogenizing channel. It may now be expedient to configure the homogenizer such that the flow resistance of the homogenizing channels increases as the distance between the homogenizing channels and the deflection axis increases, wherein in particular the channel length of the homogenizing channels increases and/or the channel cross-section of the homogenizing channels decreases. As the channel length increases and the channel cross-section decreases, the flow resistance of the respective homogenizing channel increases. This supports or generates the homogenizing effect of the homogenizer. In a simple embodiment, the channel cross-sections of all homogenizing channels may be of equal size, so that only the channel length of the outlet channels increases with increasing distance from the deflection axis. Such an embodiment is particularly easy to manufacture. Alternatively, an embodiment is also conceivable in which the channel length is the same for all homogenizing channels, so that only the channel cross-section of the outlet channels decreases with increasing distance from the deflection axis. A combined embodiment is also conceivable in which the channel length of the outlet channels increases with increasing distance of the outlet channels from the deflection axis, while at the same time the channel cross-section of the outlet channels decreases with increasing distance of the outlet channels from the deflection axis.

It is advantageous for the homogenizing channels to run parallel to each other. This leads to homogenization with regard to the flow direction in the exhaust air flow downstream of the homogenizer.

A adaptation in which the outlet channels run parallel to the vertical direction of the housing is particularly advantageous. In this case, the exhaust air flow is homogenized parallel to the vertical direction of the housing, which particularly favors the inflow of the exhaust air flow to the exhaust air outlet.

In an advantageous embodiment, the deflection region can be adapted so that it deflects the exhaust air flow by at least 45° relative to a deflection axis running parallel to the longitudinal direction of the housing, so that the exhaust air flow in the exhaust air discharge chamber flows away from the water collection chamber from the wall opening. While the gaseous exhaust air flow can easily follow this flow deflection, the liquid water droplets carried along in the exhaust air flow cannot follow this flow deflection due to their greater mass. In this way, precipitation of the entrained water on the partition wall or side wall mentioned above in the deflection region is promoted, so that a relatively large amount of water can be fed to the wall opening. In particular, the deflection region can be adapted so that it deflects the exhaust air flow by substantially about 90° with respect to the deflection axis. For example, the exhaust air flow can flow parallel to the transverse direction of the housing toward the wall opening and, after deflection in the deflection region, flow substantially parallel to the vertical direction of the housing away from the wall opening toward the exhaust air outlet.

In the advantageous embodiment, the partition wall in the deflection region can extend in a curved manner to support the deflection of the exhaust air flow. A curved partition wall or a curved section of the partition wall promotes low-resistance flow deflection, which reduces pressure loss in the exhaust air flow as it passes through the humidifier. For example, the partition wall in the deflection region may be curved toward the exhaust air discharge chamber.

Another advantageous embodiment proposes that the partition wall has a distance measured in the vertical direction of the housing from an outlet side of the humidifier block at which the dehumidified exhaust air flow exits the humidifier block. This distance can now increase along the outlet side of the humidifier block in a flow direction that the exhaust air flow has in the exhaust air discharge chamber. In this way, a pressure drop or pressure loss in the exhaust air flow is reduced. The volume of the exhaust air flow increases along the outlet side of the humidifier block in the flow direction. Since the distance along the outlet side also increases, a greater cross-sectional area is available for the increased volume flow, enabling a homogeneous exhaust air flow to be achieved, which is characterized by a low pressure drop.

Further important features and advantages of the invention are apparent from the subclaims, the drawings, and the accompanying description of the figures based on the drawings.

It is understood that the above-mentioned features and those yet to be explained below can be used not only in the combination indicated in each case, but also in other combinations or on their own, without deviating from the scope of the invention. The above-mentioned components of a superordinate unit, such as a setup, an apparatus, or an arrangement, which are designated separately, can form separate parts or components of this unit or be integral regions or sections of this unit, even if this is shown differently in the drawings.

Preferred exemplary embodiments of the invention are shown in the drawings by way of example and will be explained in more detail in the following description, wherein identical reference numbers refer to identical or similar or functionally identical elements.

### BRIEF DESCRIPTION OF THE DRAWINGS

The drawings, each schematically, show in:

FIG. 1 shows a highly simplified sectional view of a humidifier in the area of a water collection chamber,

FIGS. 2 and 3 each show a schematic diagram of a fuel cell system with a humidifier in two alternative embodiments,

FIGS. 4 and 5 each show an isometric sectional view of the humidifier in a deflection region in different specific embodiments.

### DETAILED DESCRIPTION

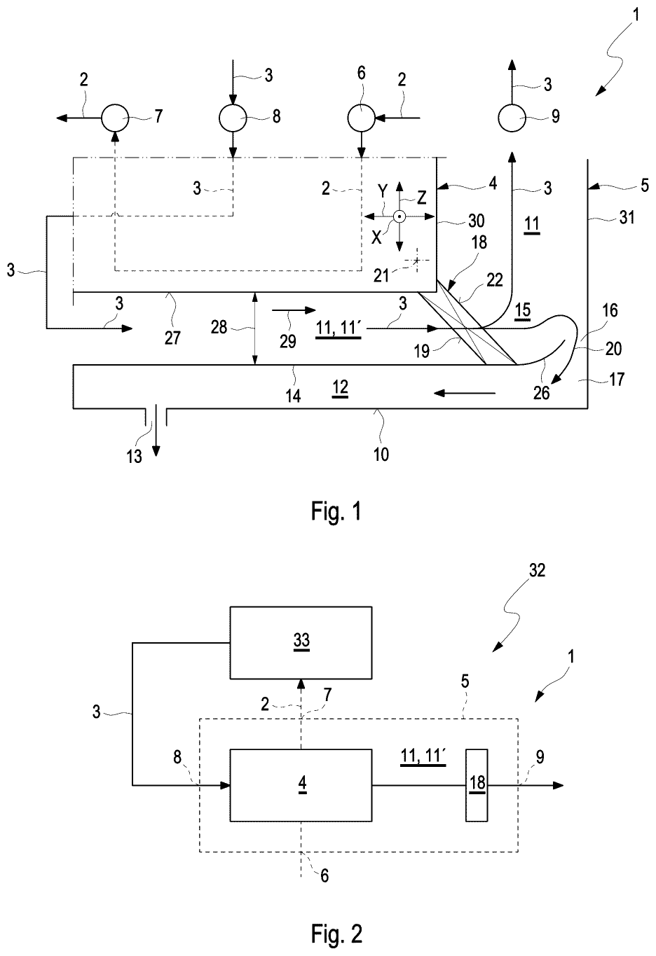

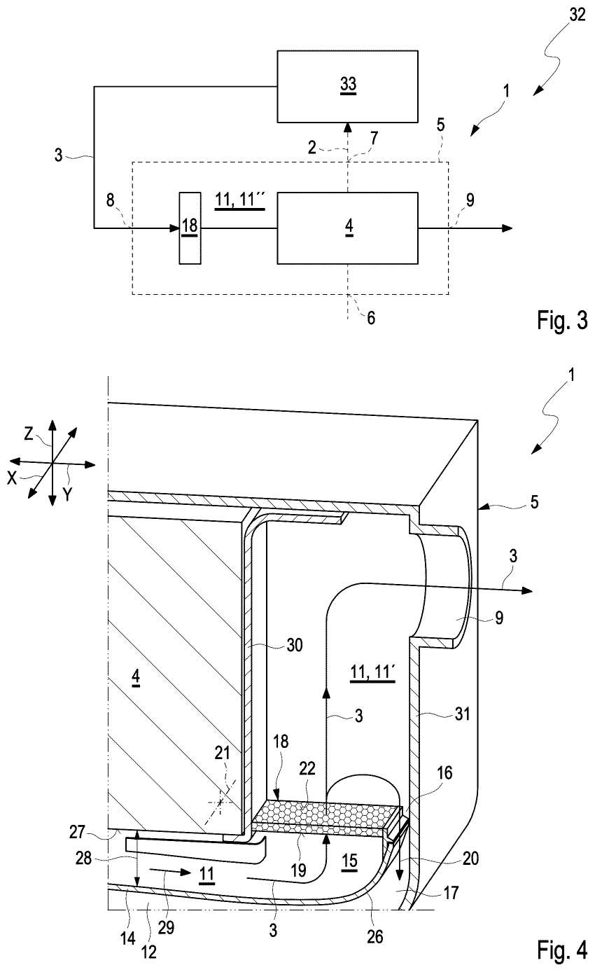

According to FIGS. 1 to 3, an humidifier 1 comprises means for transferring humidity from a humid exhaust air flow 3 to a dry supply air flow 2 for a fuel cell system 32, which is simplified in FIGS. 2 and 3, in particular of a motor vehicle not shown here, comprises a humidifier block 4, which can be flowed through by the exhaust air flow 3 of the fuel cell system 32 and by the supply air flow 2 of the fuel cell system 32 in a media-separated manner and is adapted such that humidity, i.e., water, is transferred from the exhaust air flow 3 to the supply air flow 2 when it is flowed through. The humidifier 1 also has a housing 5 in which the humidifier block 4 is arranged. The housing 5 defines, in accordance with FIGS. 1, 4, and 5, a longitudinal direction of the housing X, a transverse direction of the housing Y, and a vertical direction of the housing Z, which run perpendicular to each other. In FIG. 1, the longitudinal direction of the housing X is perpendicular to the plane of the drawing. The transverse direction of the housing Y extends substantially horizontally in FIGS. 1, 4, and 5, while the vertical direction of the housing Z extends substantially vertically in FIGS. 1, 4, and 5.

According to FIGS. 2 and 3, the fuel cell system 32 has a fuel cell stack 33, to which the humidified supply air flow 2 is fed during operation and from which the humid exhaust air flow 3 is discharged during operation.

According to FIGS. 1 to 3, the housing 5 has an exhaust air inlet 8 for supplying the humid exhaust air flow 3 to the humidifier block 4, an exhaust air outlet 9 for discharging the dehumidified exhaust air flow 3 from the humidifier block 4, a supply air inlet 6 for supplying the dry supply air flow 2 to the humidifier block 4, and a supply air outlet 7 for discharging the humidified supply air flow 2 from the humidifier block 4.

In the humidifier 1 presented here, a homogenizer 18 for homogenizing the exhaust air flow 3 is arranged in the housing 5, through which the exhaust air flow 3 can flow, and which is shown in simplified form in FIGS. 1 to 4. According to FIG. 2, the homogenizer 18 in the housing 5 can be arranged downstream of the humidifier block 4 with respect to the exhaust air flow 3, i.e., with respect to a flow direction of the exhaust air flow 3 between the humidifier block 4 and the exhaust air outlet 9. Alternatively, as shown in FIG. 3, the homogenizer 18 in the housing 5 can be arranged upstream of the humidifier block 4 with respect to the exhaust air flow 3, i.e., with respect to the flow direction of the exhaust air flow 3 between the humidifier block 4 and the exhaust air inlet 8. In the examples shown in FIGS. 1, 4, and 5, the homogenizer 18 is located downstream of the humidifier block 4, i.e., as shown in FIG. 2, it is arranged downstream of the humidifier block 4 in the housing 5 with respect to the exhaust air flow 3.

The homogenizer 18 according to FIGS. 1 to 5 can be arranged in a chamber 11 through which the exhaust air flow 3 can pass and can be adapted such that it feeds liquid water present by the homogenizer 18 to a wall opening 16 which connects the chamber 11 to a water collection chamber 12.

According to FIGS. 1, 2, 4, and 5, the chamber 11 in which the homogenizer 18 is arranged can be an exhaust air discharge chamber, which is subsequently referenced as 11′. The exhaust air discharge chamber 11′discharges the exhaust air flow 3 from the humidifier block 4 and feeds it to the exhaust air outlet 9. In this case, the liquid water in the humidifier block 4 can be used to transfer humidity to the supply air flow 2, as it is only separated downstream of the humidifier block 4. In the alternative embodiment shown in FIG. 3, however, it may be provided that the chamber 11 in which the homogenizer 18 is arranged is an exhaust air supply chamber, which is subsequently referred to as 11′. The exhaust air supply chamber 11″ discharges the exhaust air flow 3 from the exhaust air inlet 8 to the humidifier block 4. At this point, a particularly large amount of liquid water can be separated from the exhaust air flow 3. However, the preferred embodiment is shown in FIGS. 1, 2, 4, and 5, in which the homogenizer 18 is arranged in the exhaust air discharge chamber 11′.

According to FIGS. 1, 4, and 5, the exhaust air discharge chamber 11′in the housing 5 can be formed on a housing underside 10 with respect to the vertical direction of the housing Z. Furthermore, a water collection chamber 12 is formed in the housing 5 on the housing underside 10 relative to the vertical direction of the housing Z below the exhaust air discharge chamber 11′, which has a water drainage opening 13 and is separated from the exhaust air discharge chamber 11′ by means of a partition wall 14. The exhaust air discharge chamber 11′ has a deflection region 15 between the humidifier block 4 and the exhaust air outlet 9, which is adapted to deflect the exhaust air flow 3. In the embodiments shown here, the exhaust air flow 3 flows substantially horizontally from left to right up to the deflection region 15. From the deflection region 15, the exhaust air flow 3 flows substantially vertically, from bottom to top.

According to FIGS. 1, 4, and 5, the partition wall 14 has a wall opening 16 in the deflection region 15, which fluidically connects the water collection chamber 12 to the exhaust air discharge chamber 11′. During operation of the humidifier 1, the exhaust air flow 3 does not flow through the water collection chamber 12, resulting in the formation of a dead space 17 in the region of the wall opening 16. Water that condenses on the partition wall 14 is fed by the exhaust air flow 3 to the wall opening 16 and passes through it into the water collection chamber 12. This results in water separation 20. This water separation 20 or the supply of water to the water collection chamber 12 is indicated in FIGS. 1, 4, and 5 by an arrow 20.

The exhaust air discharge chamber 11′ is bounded below the humidifier block 4 and in the

deflection region 15 on the inlet side in the vertical direction of the housing Z by the partition wall 14. Furthermore, the exhaust air discharge chamber 11′ is bounded in the deflection region 15 and subsequently in the direction of the exhaust air outlet 9 transversely to the vertical direction of the housing Z, preferably in the transverse direction of the housing Y, by a side wall 31 of the housing 5. It may now be expedient to provide that the wall opening 16 in or on the partition wall 14 is positioned such that the wall opening 16 adjoins this side wall 31 or is bounded by this side wall 31. This has the advantage that water accumulating on this side wall 31 can flow along the side wall 31 due to the effect of gravity and enter the water collection chamber 12 through the partition wall 16.

The deflection region 15 is adapted here such that it deflects the exhaust air flow 3 by substantially about 90° relative to a deflection axis 21 running parallel to the longitudinal direction of the housing X, such that the exhaust air flow 3 flows away from the water collection chamber 12 in the exhaust air discharge chamber 11′ from the wall opening 16. In the examples shown in FIGS. 1, 4, and 5, the exhaust air flow 3 flows substantially vertically upward after being deflected from the wall opening 16. In the examples shown here, the flow deflection is oriented counterclockwise with respect to the deflection axis 21.

Water separation 20 can already be achieved by the targeted positioning and dimensioning of the wall opening 16 in the deflection region 15. The homogenizer 18 can significantly improve water separation 20.

According to FIGS. 1, 4, and 5, the homogenizer 18 can be arranged in the deflection region 15, can be traversed by the exhaust air flow 3, and can be adapted to homogenize the exhaust air flow 3. The homogenizer 18 has an upstream side 19, at which the exhaust air flow 3 flows into the homogenizer 18, and a downstream side 22, at which the exhaust air flow 3 flows out of the homogenizer 18. The homogenizer 18 is arranged in the deflection region 15 such that the downstream side 22 directs water present by the downstream side 22 to the wall opening 16. The homogenizer 18 homogenizes the exhaust air flow 3 with regard to the distribution of the flow velocity within the flow cross-section of the exhaust air discharge chamber 11′ downstream of the homogenizer 18 or downstream of the deflection region 15. This makes it easier to separate water from the exhaust air flow 3. The water can accumulate on the downstream side 22 and is directed from there to the wall opening 16. From the wall opening 16, the water enters the water collection chamber 12 in accordance with the water separation 20.

The wall opening 16 conveniently adjoins the homogenizer 18 on a side facing away from the deflection axis 21. Similarly, the homogenizer 18 may be arranged in the housing 5 between the deflection axis 21 and the wall opening 16. In addition, it may be preferable to configure the homogenizer 18 such that the flow resistance of the homogenizer 18 increases with increasing distance from the deflection axis 21. For example, according to FIG. 5, it may be provided that a thickness of the homogenizer 18 measured in the flow direction increases with increasing distance from the deflection axis 21.

According to FIG. 5, the homogenizer 18 is conveniently arranged in the deflection region 15 such that the downstream side 22 is located above the wall opening 16 in relation to the vertical direction of the housing Z or is flush with the wall opening 16. This allows water flowing down the downstream side 22 toward the wall opening 16 to enter the wall opening 16 continuously and thus unhindered, and thereby be drained away. In the examples shown here, the downstream side 22 extends flat and substantially transverse to the vertical direction of the housing Z. In particular, the downstream side 22 may be inclined at a comparatively small angle of less than 10° relative to the vertical direction of the housing Z, such that the downstream side 22 slopes toward the wall opening 16. Furthermore, the homogenizer 18 may be designed to completely fill the traversable cross-section of the exhaust air discharge chamber 11′ upstream of the wall opening 16. This avoids leaks that bypass the homogenizer 18.

According to FIG. 5, the homogenizer 18 has several homogenizing channels 23 through which the exhaust air can flow in parallel. The homogenizing channels 23 each have a channel length 24 measured in the flow direction of the exhaust air and a traversable channel cross-section 25. The alignment of the homogenizer 18 transverse to the flow direction of the exhaust air flow 3 results in different distances between the homogenizing channels 23 and the deflection axis 21. According to the advantageous embodiments shown here, it can now be provided that the channel length 24 of the homogenizing channels 23 increases with increasing distance of the homogenizing channels 23 from the deflection axis 21. With regard to a curve resulting from the deflection in the deflection region 15, according to FIG. 5, the homogenizing channels 23 inside the curve are shorter than the outlet channels 23 outside the curve. In the example shown here, the channel length 24 increases continuously or linearly with increasing distance of the outlet channels 23 from the deflection axis 21. A progressive or even a degressive increase in the channel length 24 with increasing distance from the deflection axis 21 is also conceivable. In an alternative embodiment, it may be provided that the channel cross-section 25 of the outlet channels 23 decreases as the distance between the homogenizing channels 23 and the deflection axis 21 increases. In another embodiment, it may be provided that as the distance between the outlet channels 23 and the deflection axis 21 increases, the channel length 24 of the homogenizing channels 23 increases, while the channel cross-section 25 of the outlet channels 23 decreases. Similarly, an embodiment is also conceivable in which the channel length 24 and also the channel cross-section 25 increase or decrease as the distance from the deflection axis 21 increases, wherein the channel lengths 24 and the channel cross-sections 25 are coordinated with each other such that the flow resistance increases as the distance from the deflection axis 21 increases.

In the example shown here, the homogenizing channels 23 each run in a straight line and parallel to each other and parallel to the vertical direction of the housing Z. In addition, the upstream side 19 and the downstream side 22 are each designed to be flat and inclined toward each other, so that the homogenizer 18 has a wedge-shaped cross-section transverse to the longitudinal direction of the housing X.

The partition wall 14 is suitably curved, at least in the deflection region 15, as shown in FIGS. 1, 4, and 5, such that a curved section 26 of the partition wall 14 supports the deflection of the exhaust air flow 3. In the examples shown, the partition wall 14 is curved in its curved section 26, i.e., in the deflection region 15 towards the exhaust air discharge chamber 11′.

According to FIGS. 1, 4, and 5, the partition wall 14 has a distance 28 measured in the

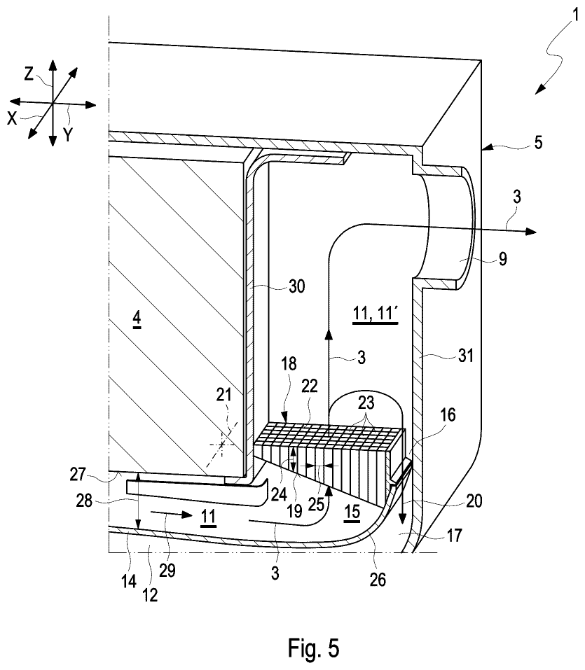

vertical direction of the housing Z from an outlet side 27 of the humidifier block 4, at which the dehumidified exhaust air flow 3 exits from the humidifier block 4. In the example shown in FIG. 1, the distance 28 is constant along the outlet side 27 of the humidifier block 4 in a flow direction 29, which is the direction of the exhaust air flow 3 in the exhaust air discharge chamber 11′. In the examples shown in FIGS. 1, 4, and 5, the flow direction 29 extends horizontally and from left to right below the humidifier block 4. In the examples shown in FIGS. 4 and 5, however, the partition wall 14 is shaped or adapted such that the distance 28 between the outlet side 27 of the humidifier block 4 and the partition wall 14 increases in the flow direction 29 along the outlet side 27. In or at the deflection region 15, the distance 28 in FIGS. 4 and 5 reaches its maximum. There is a maximum volume flow of the exhaust air flow 3 at this point. The exhaust air discharge chamber 11′ is bounded downstream of the homogenizer 18 on the one hand by an intermediate wall 30 and on the other hand by a side wall 31. The homogenizer 18 preferably fills the entire traversable cross-section of the exhaust air discharge chamber 11′. For this purpose, the homogenizer 18 extends from the intermediate wall 30 to the partition wall 14, namely to the section 26 of the partition wall 14 adjacent to the wall opening 16. The wall opening 16 extends from the side wall 31 to the partition wall 14, namely to the section 26 of the partition wall 14 adjacent to the wall opening 16.

Various examples/embodiments are described herein for various apparatuses, systems, and/or methods. Numerous specific details are set forth to provide a thorough understanding of the overall structure, function, manufacture, and use of the examples/embodiments as described in the specification and illustrated in the accompanying drawings. It will be understood by those skilled in the art, however, that the examples/embodiments may be practiced without such specific details. In other instances, well-known operations, components, and elements have not been described in detail so as not to obscure the examples/embodiments described in the specification. Those of ordinary skill in the art will understand that the examples/embodiments described and illustrated herein are non-limiting examples, and thus it can be appreciated that the specific structural and functional details disclosed herein may be representative and do not necessarily limit the scope of the embodiments.

Reference throughout the specification to “examples, “in examples,” “with examples,” “various embodiments,” “with embodiments,” “in embodiments,” or “an embodiment,” or the like, means that a particular feature, structure, or characteristic described in connection with the example/embodiment is included in at least one embodiment. Thus, appearances of the phrases “examples, “in examples,” “with examples,” “in various embodiments,” “with embodiments,” “in embodiments,” or “an embodiment,” or the like, in places throughout the specification are not necessarily all referring to the same embodiment. Furthermore, the particular features, structures, or characteristics may be combined in any suitable manner in one or more examples/embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof.

It should be understood that references to a single element are not necessarily so limited and may include one or more of such element. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of examples/embodiments.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first element could be termed a second element, and, similarly, a second element could be termed a first element, without departing from the scope of the various described embodiments. The first element and the second element are both elements, but they are not the same element.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the phrase “at least one of” followed by successive elements separate by the word “and” (e.g., “at least one of A and B”) is to be interpreted the same as “and/or” and as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Joinder references (e.g., attached, coupled, connected, and the like) are to be construed broadly and may include intermediate members between a connection of elements, relative movement between elements, direct connections, indirect connections, fixed connections, movable connections, operative connections, indirect contact, and/or direct contact. As such, joinder references do not necessarily imply that two elements are directly connected/coupled and in fixed relation to each other. Connections of electrical components, if any, may include mechanical connections, electrical connections, wired connections, and/or wireless connections, among others. Uses of “e.g.” and “such as” in the specification are to be construed broadly and are used to provide non-limiting examples of embodiments of the disclosure, and the disclosure is not limited to such examples.

While processes, systems, and methods may be described herein in connection with one or more steps in a particular sequence, it should be understood that such methods may be practiced with the steps in a different order, with certain steps performed simultaneously, with additional steps, and/or with certain described steps omitted.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

All matter contained in the above description or shown in the accompanying drawings shall be interpreted as illustrative only and not limiting. Changes in detail or structure may be made without departing from the present disclosure.

1. A humidifier for transferring humidity from an exhaust air flow to a supply air flow for a fuel cell system, comprising:
a humidifier block through which the exhaust air flow and the supply air flow are flowable in a media-separated manner such that humidity from the exhaust air flow is transferrable to the supply air flow;
a housing in which the humidifier block is arranged, the housing having a longitudinal direction, a transverse direction, and a vertical direction extending perpendicular to each other;
the housing including:
an exhaust air inlet via which the exhaust air flow is suppliable to the humidifier block;
an exhaust air outlet via which the exhaust air flow is dischargeable from the humidifier block;
a supply air inlet via which the supply air flow is suppliable to the humidifier block; and
a supply air outlet via which the supply air flow is dischargeable from the humidifier block; and
a homogenizer through which the exhaust air flow is flowable, the homogenizer arranged in the housing and configured to homogenize the exhaust air flow.

2. The humidifier according to claim 1, wherein the homogenizer is arranged in a chamber through which the exhaust air flow is passable and is adapted to direct water present by the homogenizer to a wall opening which connects the chamber to a water collection chamber.

3. The humidifier according to claim 2, wherein the chamber is an exhaust air discharge chamber adapted to discharge the exhaust air flow from the humidifier block and feed the exhaust air flow to the exhaust air outlet.

4. The humidifier according to claim 2, wherein the chamber is an exhaust air supply chamber adapted to divert the exhaust air flow from the exhaust air inlet and feed the exhaust air flow to the humidifier block.

5. The humidifier according to claim 2, wherein:
the homogenizer has a downstream side; and
the homogenizer is arranged in the chamber such that the downstream side directs water present by the downstream side toward the wall opening.

6. The humidifier according to claim 5, wherein the downstream side of the homogenizer is disposed above the wall opening with respect to the vertical direction of the housing.

7. The humidifier according to claim 5, wherein the downstream side of the homogenizer extends transversely to the vertical direction of the housing and slopes down toward the wall opening.

8. The humidifier according to claim 5, wherein the homogenizer fills a traversable cross-section of the chamber disposed upstream of the wall opening.

9. The humidifier according to claim 5, wherein the downstream side of the homogenizer is level.

10. The humidifier according to claim 2, wherein:
the chamber has a deflection region which deflects the exhaust air flow; and
the wall opening and the homogenizer are arranged in the deflection region of the chamber.

11. The humidifier according to claim 10, wherein:
the deflection region of the chamber is adapted to deflect the exhaust air flow with respect to a deflection axis extending parallel to the longitudinal direction of the housing; and
the wall opening adjoins the homogenizer on a side facing away from the deflection axis.

12. The humidifier according to claim 10, wherein:
the deflection region of the chamber is adapted to deflect the exhaust air flow with respect to a deflection axis extending parallel to the longitudinal direction of the housing; and
the homogenizer is arranged in the housing between the deflection axis and the wall opening.

13. The humidifier according to claim 10, wherein:
the deflection region of the chamber is adapted to deflect the exhaust air flow with respect to a deflection axis extending parallel to the longitudinal direction of the housing; and
a flow resistance of the homogenizer increases with increasing distance from the deflection axis.

14. The humidifier according to claim 1, wherein the homogenizer includes a plurality of homogenizing channels through which the exhaust air flow is flowable in parallel and which are aligned parallel to one another, the plurality of homogenizing channels each having:
a flow resistance;
a channel length extending in a flow direction of the exhaust air flow; and
a channel cross-section through which the exhaust air flow is flowable.

15. The humidifier according to claim 14, wherein:
the homogenizer is arranged in a chamber through which the exhaust air flow is passable and is adapted to direct water present by the homogenizer to a wall opening which connects the chamber to a water collection chamber;
the chamber has a deflection region adapted to deflect the exhaust air flow with respect to a deflection axis extending parallel to the longitudinal direction of the housing;
the wall opening and the homogenizer are arranged in the deflection region of the chamber; and
as a distance between a homogenizing channel of the plurality of homogenizing channels and the deflection axis increases, the flow resistance of the homogenizing channel increases.

16. The humidifier according to claim 5, wherein the downstream side of the homogenizer is disposed flush with the wall opening.

17. A humidifier for transferring humidity from an exhaust air flow to a supply air flow for a fuel cell system, comprising:
a humidifier block through which the exhaust air flow and the supply air flow are flowable in a media-separated manner such that humidity from the exhaust air flow is transferrable to the supply air flow;
a housing in which the humidifier block is arranged, the housing having a longitudinal direction, a transverse direction, and a vertical direction extending perpendicular to each other, the housing including:
an exhaust air inlet via which the exhaust air flow is suppliable to the humidifier block;
an exhaust air outlet via which the exhaust air flow is dischargeable from the humidifier block;
a supply air inlet via which the supply air flow is suppliable to the humidifier block; and
a supply air outlet via which the supply air flow is dischargeable from the humidifier block;
an air chamber disposed in the housing;
a water collection chamber disposed in the housing below the air chamber relative to the vertical direction of the housing;
a homogenizer through which the exhaust air flow is flowable, the homogenizer arranged in the air chamber and configured to homogenize the exhaust air flow;
a partition wall disposed between and separating the air chamber and the water collection chamber; and
a wall opening through which water is flowable from the air chamber to the water collection chamber.

18. The humidifier according to claim 17, wherein the partition wall includes a curved deflection section that redirects the exhaust air flow flowing through a downstream region of the air chamber toward the homogenizer.

19. The humidifier according to claim 17, wherein the wall opening is at least partially defined by and between the partition wall and a vertically extending side wall of the housing.

20. The humidifier according to claim 19, wherein the homogenizer is arranged adjacent to an end of the partition wall that partially defines the wall opening.
